(19) United States
(12) Patent Application Publication
(10) Pub. No.: US 2025/0222367 A1
(43) Pub. Date: Jul. 10, 2025

(54) Plush Toy with Appendages that Outline a Heart Shape

(71) Applicant: Good Soul Brands LLC, Parlin, NJ (US)

(72) Inventor: Drew Matilsky, Parlin, NJ (US)

(21) Appl. No.: 18/833,609

(22) PCT Filed: Jan. 28, 2022
(86) PCT No.: PCT/US2022/014299

§ 371 Date: Jul. 29, 2024

(51) Int. Cl. A63H 3/02

(52) U.S. Cl. CPC A63H 3/02

(57) ABSTRACT

A plush toy includes a body, first and second extremities extending from the body, a first appendage carried on the first extremity and a second appendage carried on the second extremity. The first appendage outlines a first portion of a heart shape. The second appendage outlines a second portion of the heart shape. When the first and second appendages are placed together, they outline a complete heart shape.

### TECHNICAL FIELD

This document relates generally to the field of plush toys and, more particularly, to a plush toy that includes appendages that when placed together outline a heart shape.

### BACKGROUND

This document discloses a huggable and loveable plush toy that is weighted to provide therapeutic benefits. The comforting pressure provided by the weighted plush toy against the body of the holder serves to ease any anxiety and creates a sense of peace. The “hug” of the plush toy provides sensory stimulation and generates a calming sensation. The heart shaped outline provided when the appendages or hands of the plush toy are brought together provides a visual confirmation of the love bond between the plush toy and the child to which the plush toy belongs.

### SUMMARY

In accordance with the purposes and benefits set forth herein, a new and improved plush toy is provided. That plush toy comprises: (a) a body, (b) a first extremity extending from the body, (c) a second extremity extending from the body, (d) a first appendage carried on the first extremity and (e) a second appendage carried on the second extremity. The first appendage outlines a first portion of a heart shape. The second appendage outlines a second portion of the heart shape. When said first and second appendages are placed together, the first and second appendages outline the complete heart shape demonstrating the love bond between the plush toy and the child to which the plush toy belongs.

In one or more of the many possible embodiments of the plush toy, the first appendage includes a first digit and a second digit at a free end of said first extremity. In one or more of the many possible embodiments of the plush toy, the second appendage includes a third digit and a fourth digit at a free end of said second extremity.

In one or more of the many possible embodiments of the plush toy, the plush toy includes a head carried on the body. The head may include a first set of eyes on a first or front side and a second set of eyes on a second or back side. The first set of eyes may be closed. The second set of eyes may be open.

The head may also include a mouth on the first side. The plush toy may further include a first ear and a second ear extending from the head. The first ear and the second ear may be adapted to allow the first ear and the second ear to be independently folded over the first side or the second of the head as desired by a child.

In one or more of the many possible embodiments of the plush toy, the plush toy includes a first leg and a second leg extending from the body. The plush toy may also include a first foot at an end of the first leg and a second foot at an end of the second leg.

In one or more of the many possible embodiments of the plush toy, the first foot and the second foot are weighted with bags of aggregate material.

In one or more of the many possible embodiments of the plush toy, the first extremity is segmented into a first plurality of compartments and the second extremity is segmented into a second plurality of compartments. The first plurality of compartments and the second plurality of compartments are each weighted with bags of aggregate material. The first appendage and the second appendage may also be weighted with bags of aggregate material.

In one or more of the many possible embodiments of the plush toy, the first plurality of compartments may increase in weight from the body toward the first appendage. Further, the first appendage may weigh more than any one of the first plurality of compartments.

In one or more of the many possible embodiments of the plush toy, the second plurality of compartments may increase in weight from the body toward the second appendage. Further, the second appendage may weigh more than any one of the second plurality of compartments.

In the following description, there are shown and described several different embodiments of the plush toy with appendages that outline a heart shape. As it should be realized, the plush toy is capable of other, different embodiments and its several details are capable of modification in various, obvious aspects all without departing from the plush toy as set forth and described in the following claims. Accordingly, the drawing figures and descriptions should be regarded as being illustrative in nature rather than restrictive.

### BRIEF DESCRIPTION OF THE DRAWING FIGURES

The accompanying drawing figures incorporated herein and forming a part of the specification, illustrate several aspects of the plush toy with appendages that outline a heart shape and together with the description serve to explain certain principles thereof.

FIG. 1 is a front elevational view of one possible embodiment of the new and improved plush toy with the ears thereof extending upward.

FIG. 2 is a rear elevational view of one possible embodiment of the new and improved plush toy with the ears thereof extending upward.

FIG. 3 is a front elevational view of one possible embodiment of the new and improved plush toy with the ears thereof extending downward over the face of the plush toy.

FIG. 4 is a rear elevational view of one possible embodiment of the new and improved plush toy with the ears thereof extending downward over the open eyes of the plush toy looking out from the back of the plush toy's head.

FIG. 5 is a detailed view of one of the extremities of the plush toy illustrating the plurality of compartments that constitute the segmented nature of that extremity.

FIG. 6 is a detailed rear elevational view of the first or right appendage that outlines a first portion of a heart shape.

FIG. 7 is a detailed rear elevational view of the second or left appendage that outlines a second portion of the heart shape.

FIG. 8 is a front elevational view of the plush toy with the appendages brought or placed together to form a full and complete heart shape indicative of the love bond between the plush toy and the child to which the plush toy belongs.

Reference is now made in detail to the present preferred embodiments of the plush toy, examples of which are illustrated in the accompanying drawing figures.

### DETAILED DESCRIPTION

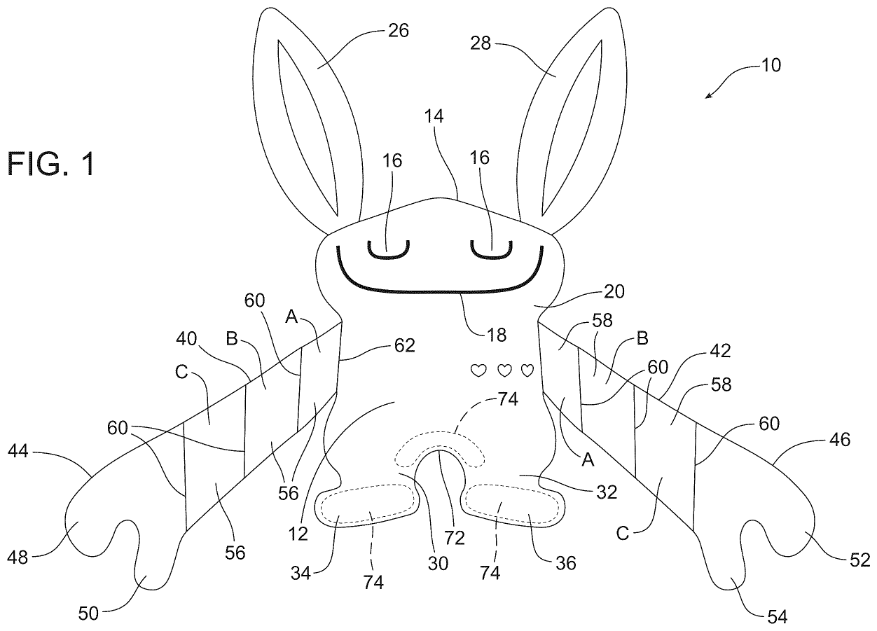

Reference is now made to FIGS. 1-8 that illustrate the new and improved plush toy 10. That plush toy 10 includes a body 12 made from a soft fabric material, such as Super-soft velvet, polyester or super-soft spandex that is stuffed with a resilient, cushion-like material (hidden from view) such as polyester fiber 7D, polyester fiber 15D or Down cotton 0.9D.

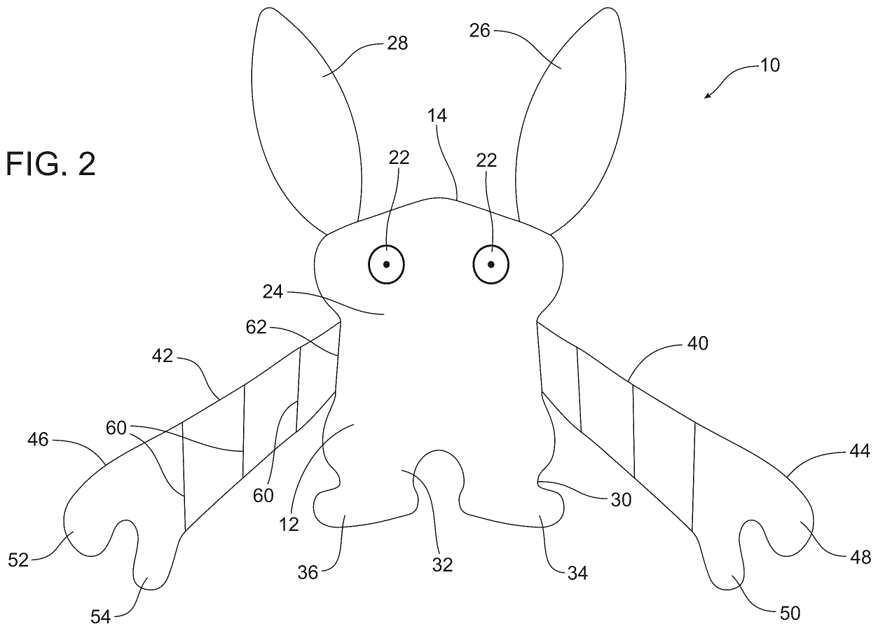

A head 14 is carried on the body 12. The head 14 includes a first set of eyes 16 and a month 18 on the first or front side 20 (see FIG. 1) and a second set of eyes 22 on a second or rear side 24 (see FIG. 2). The first set of eyes 16 are closed. The second set of eyes 22 are open.

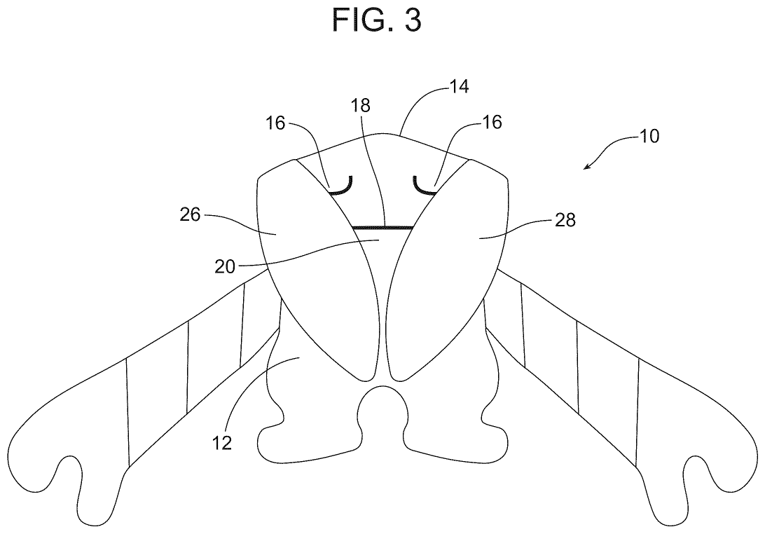

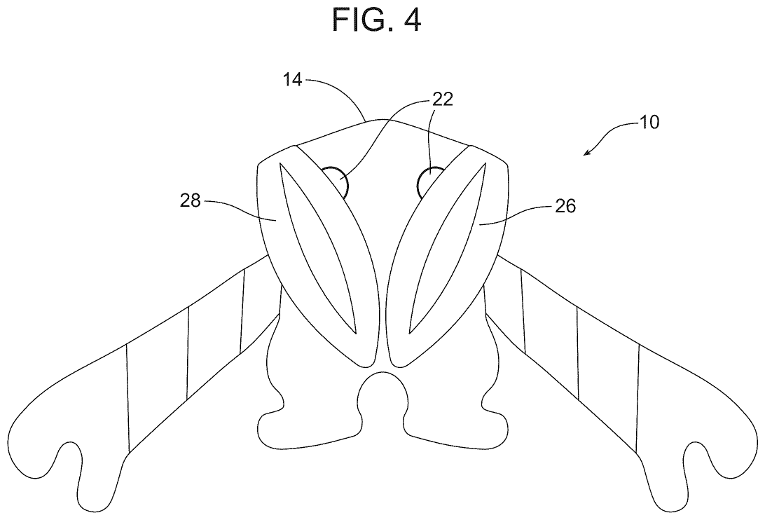

First and second ears 26, 28, respectively, extend from the head 14 (see FIGS. 1 and 2). The first and second ears 26, 28 are adapted to allow for independent folding over the first side 20 or the second side 24 of the head 14 as desired. For example, FIG. 3 illustrates both ears 26, 28 folded down over the first side 20 of the head 14 so as to partially cover the first set of eyes 16 and the mouth 18. FIG. 4 illustrates both ears 26, 28 folded down over the second side 24 besides the open second set of eyes 22. Either or both ears 26, 28 may assume the illustrated positions as they move independent of one another.

As further illustrated in FIGS. 1-4 a first or right leg 30 and a second or left leg 32 extend from the body 12 substantially across from the head 14. A first or right foot 34 is provided at the end of the first leg 30 and a second or left foot 36 is provided at the end of the second leg 32.

A first extremity 40 and a second extremity 42 also extend from the body 12. A first appendage 44 is carried on the end of the first extremity 40. A second appendage 46 is carried on the end of the second extremity 42. The first appendage 44 includes a first digit 48 and a second digit 50 at the free end of the first extremity 40. The second appendage 46 includes a third digit 52 and a fourth digit 54 at the free end of the second extremity 42. In the illustrated embodiment, the first extremity 40 takes the form of a right arm and the second extremity 42 takes the form of a left arm. The first appendage 44 takes the form of a right hand and the second appendage 46 takes the form of a left hand. See FIG. 2-4.

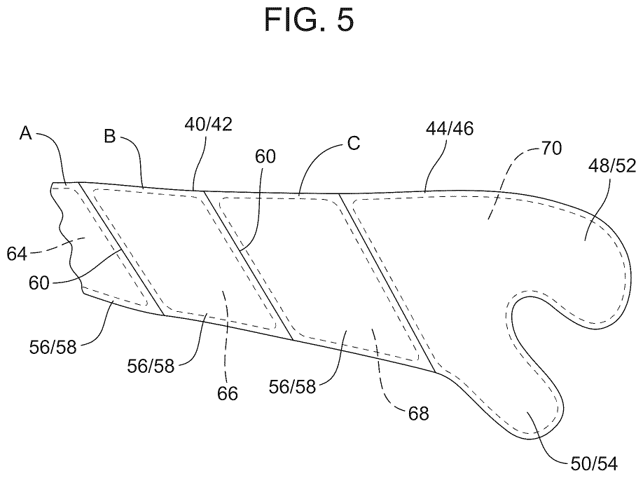

Reference is now made to FIG. 5 which illustrates either one of the first and second extremities 40, 42 in detail. As illustrated, the first extremity 40 is segmented into a first plurality of compartments 56 and the second extremity 42 is segmented into a second plurality of compartments 58. More particularly, seam lines 60 divide each extremity 40,42 into three compartments A, B and C as shown. Compartment A is attached by a seam 62 to the body 12, compartment C is attached by a seam 60 to one of the appendages 44, 46 and compartment B is connected by seams 60 to compartments A and C. In the illustrated embodiment, the compartments A, B and C increase in size from the body 12 toward the appendage 44, 46: that is compartment B is larger than compartment A and compartment C is larger than compartment B.

The first and second plurality of compartments 56, 58/A, B and C may be made with the same outer material as the body 12 described above. The compartments A, B and C are stuffed, respectively, with bags of an aggregate material 64, 66 and 68 so that the compartments A, B and C increase in weight from the body 12 toward the appendage 44, 46: that is, compartment B weighs more than compartment A and compartment C weighs more than compartment B.

In addition, the first and second appendages 44, 46 are also weighted with bags of aggregate material 70 so that the first appendage 44 weighs more than any one of the first plurality of compartments 56/A, B and C and the second appendage 46 weighs more than any one of the second plurality of compartments 58/A, B and C.

For example, in one possible embodiment of the plush toy 10, the aggregate material is selected from a group of materials including, but not necessarily limited to, ceramic particles, glass particles or plastic particles and the bags of aggregate material weight as follows: bag 64 weighs about 20.0 grams, bag 66 weighs about 45.0 grams, bag 68 weighs about 70.0 grams and bag 70 weighs about 210 grams. The bags 64, 66, 68, 70 holding the aggregate material may be made from any material suited for the intended purpose that are stitch or otherwise closed to maintain the aggregate material within the bag should the body 12 be torn or a seam unravel for any reason.

When a child hugs the plush toy 10, the extremities or arms 40, 42 of the plush toy may be draped over the child's shoulders so as to extend down the child's back. The weight of the extremities or arms 40, 42, increasing from compartment A to compartment B to compartment C, and the even greater weight of the appendages or hands 44, 46 ensures that the child receives what feels like a hug from the plush toy 10. This generates a warm, calm and secure feeling for the child. The closed, first set of eyes 14 oriented toward the child suggests sleep to the child while the open, second set of eyes 22 looking outward watch intently for any possible danger thereby providing the child with a sense of security and safety.

The child may also carry the plush toy 10 in a piggyback manner with the weighted extremities or arms 40, 42 draped over the child's shoulders so as to extend down onto the child's chest. The weight of the extremities or arms 40, 42 creates a sensation of the plush toy 10 holding onto the child while the rearwardly oriented open, second set of eyes 22 peer rearward watching intently for any possible danger that might be following thereby again providing a greater sense of security and safety.

The feet 34, 36 and the crotch area 72 of the body 12 may also include bags of aggregate material 74 to provide a desired weight for “snuggling” against the child when the plush toy 10 is laying on top of the child such as during a nap. The head 14 of the plush toy 10 may only be stuffed with the soft, cushion like material if desired (i.e. no bags of aggregate material for added weight need to be provided in the head).

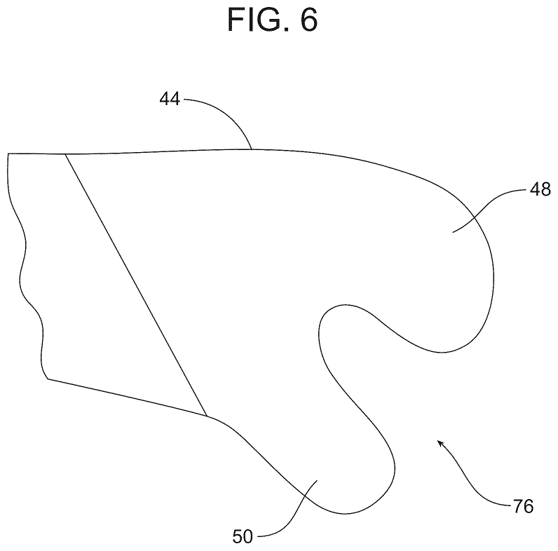

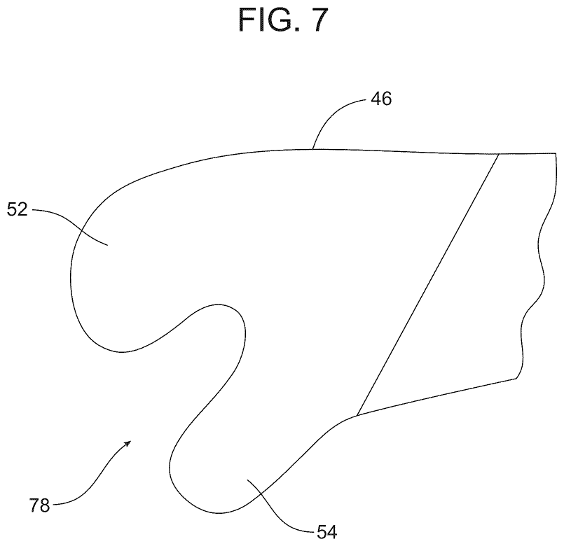

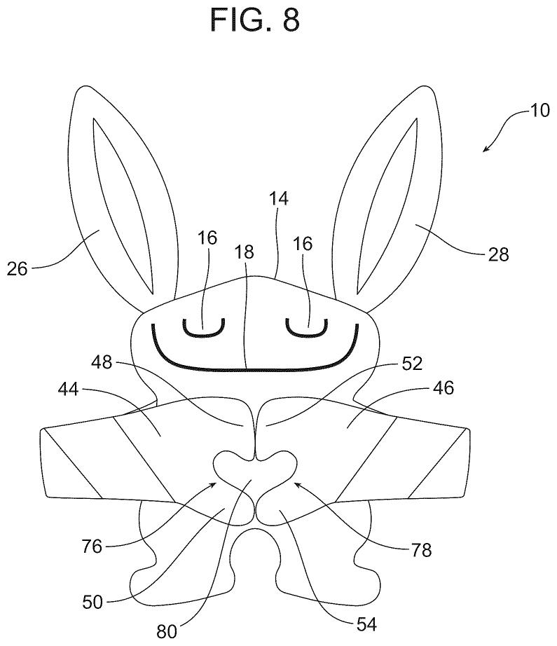

Reference is now made to FIG. 6 which illustrates the first appendage or right hand 44 and FIG. 7 which illustrates the second appendage or left hand 46. Here it should be noted how the first and second digits 48 and 50 of the first appendage 44 outline a first portion 76 of a heart shape while the third and fourth digits 52, 54 of the second appendage 46 outline a second and complementary portion 78 of a heart shape. Thus, when the first and second appendages 44, 46 are brought or placed together as illustrated in FIG. 8, the appendages, by means of their digits 48, 50, 52 and 54 outline a complete heart shape 80. This heart shape 80 is a symbol of the love bond between the plush toy 10 and the child to which the plush toy belongs.

This disclosure may be said to relate to the following items.
1. A plush toy, comprising:
a body;
a first extremity extending from the body;
a second extremity extending from the body;
a first appendage carried on the first extremity, said first appendage outlining a first portion of a heart shape; and
a second appendage carried on the second extremity, said second appendage outlining a second portion of a heart shape;
wherein, when said first and second appendages are placed together, said first and second appendages outline a heart shape.
2. The plush toy of item 1, wherein the first appendage includes a first digit and a second digit at a free end of said first extremity.
3. The plush toy of item 2, wherein the second appendage includes a third digit and a fourth digit at a free end of said second extremity.
4. The plush toy of item 3, further including a head carried on the body.
5. The plush toy of item 4, wherein said head includes a first set of eyes on a first side and a second set of eyes on a second side.
6. The plush toy of item 5, wherein the first set of eyes are closed.
7. The plush toy of item 6, wherein the second set of eyes are open.
8. The plush toy of item 7, wherein the head includes a mouth on said first side.
9. The plush toy of item 8, further including a first ear and a second ear extending from the head.
10. The plush toy of item 9, wherein the first ear and the second ear are connected to the head and adapted to allow the first ear and the second ear to be independently folded over the first side or the second side of the head as desired.
11. The plush toy of item 10, further including a first leg and a second leg extending from the body.
12. The plush toy of item 11, further including a first foot at an end of the first leg and a second foot at an end of the second leg.
13. The plush toy of item 12, wherein the first foot and the second foot are weighted with bags of aggregate material.
14. The plush toy of item 1, wherein said first extremity is segmented into a first plurality of compartments and the second extremity is segmented into a second plurality of compartments.
15. The plush toy of item 14, wherein the first plurality of compartments and the second plurality of compartments are weighted with bags of aggregate material.
16. The plush toy of item 15, wherein the first appendage and the second appendage are also weighted with bags of aggregate material.
17. The plush toy of item 16, wherein the first plurality of compartments increase in weight from the body toward the first appendage.
18. The plush toy of item 17, wherein the first appendage weighs more than any one of the first plurality of compartments.
19. The plush toy of item 18, wherein the second plurality of compartments increase in weight from the body toward the second appendage.
20. The plush toy of item 19, wherein the second appendage weighs more than any one of the second plurality of compartments.

Each of the following terms written in singular grammatical form: “a”, “an”, and “the”, as used herein, means “at least one”, or “one or more”. Use of the phrase “one or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a bag”, as used herein, may also refer to, and encompass, a plurality of bags.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

Terms of approximation, such as the terms about, substantially, approximately, etc., as used herein, refers to ±10% of the stated numerical value. It is to be fully understood that certain aspects, characteristics, and features, of the plush toy, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the plush toy which are illustratively described and presented in combination or sub-combination in the context or format of a single embodiment may also be illustratively described and presented in the context or format of a plurality of separate embodiments.

Although the plush toy has been illustratively described and presented by way of specific exemplary embodiments, and examples thereof, it is evident that many alternatives, modifications, or/and variations, thereof, will be apparent to those skilled in the art. It is intended that all such alternatives, modifications, or/and variations, fall within the spirit of, and are encompassed by, the broad scope of the appended claims.

What is claimed:

1. A plush toy, comprising:
a body;
a first extremity extending from the body;
a second extremity extending from the body;
a first appendage carried on the first extremity, said first appendage outlining a first portion of a heart shape; and
a second appendage carried on the second extremity, said second appendage outlining a second portion of a heart shape;
wherein, when said first and second appendages are placed together, said first and second appendages outline a complete heart shape.

2. The plush toy of claim 1, wherein the first appendage includes a first digit and a second digit at a free end of said first extremity.

3. The plush toy of claim 2, wherein the second appendage includes a third digit and a fourth digit at a free end of said second extremity.

4. The plush toy of claim 3, further including a head carried on the body.

5. The plush toy of claim 4, wherein said head includes a first set of eyes on a first side and a second set of eyes on a second side.

6. The plush toy of claim 5, wherein the first set of eyes are closed.

7. The plush toy of claim 6, wherein the second set of eyes are open.

8. The plush toy of claim 7, wherein the head includes a mouth on said first side.

9. The plush toy of claim 8, further including a first ear and a second ear extending from the head.

10. The plush toy of claim 9, wherein the first ear and the second ear are connected to the head and adapted to allow the first ear and the second ear to be independently folded over the first side or the second side of the head as desired.

11. The plush toy of claim 10, further including a first leg and a second leg extending from the body.

12. The plush toy of claim 11, further including a first foot at an end of the first leg and a second foot at an end of the second leg.

13. The plush toy of claim 12, wherein the first foot and the second foot are weighted with bags of aggregate material.

14. The plush toy of claim 1, wherein said first extremity is segmented into a first plurality of compartments and the second extremity is segmented into a second plurality of compartments.

15. The plush toy of claim 14, wherein the first plurality of compartments and the second plurality of compartments are weighted with bags of aggregate material.

16. The plush toy of claim 15, wherein the first appendage and the second appendage are also weighted with bags of aggregate material.

17. The plush toy of claim 16, wherein the first plurality of compartments increase in weight from the body toward the first appendage.

18. The plush toy of claim 17, wherein the first appendage weighs more than any one of the first plurality of compartments.

19. The plush toy of claim 18, wherein the second plurality of compartments increase in weight from the body toward the second appendage.

20. The plush toy of claim 19, wherein the second appendage weighs more than any one of the second plurality of compartments.
